(19) United States
(12) Patent Application Publication
(10) Pub. No.: US 2023/0274246 A1
(43) Pub. Date: Aug. 31, 2023

(54) Item and ownership authentication, management and return

(71) Applicant: Deborah Zell, San Francisco, CA (US)

(72) Inventor: Deborah Zell, San Francisco, CA (US)

(21) Appl. No.: 18/101,125

(22) Filed: Jan. 25, 2023

Related U.S. Application Data
(60) Provisional application No. 63/361,841, filed on Jan. 24, 2022.

(51) Int. Cl. G06Q 20/12; G06K 19/06

(52) U.S. Cl. CPC G06Q 20/1235; G06K 19/06037; G06Q 2220/165

(57) ABSTRACT

The invention is an identifier(device) installed by a manufacturer, qualified professional or consumer and a (method) for managing all aspects of an item’s lifecycle: ownership, anonymous return of (or communication via) the item or person/organism bearing the identifier, anonymous reward for the return of the lost item or person/organism, authentication and warranty(repair or recall) recordkeeping and management for a given item, transfer of ownership of an item, end of life recycling when the item has achieved its usable lifespan, and data generated from the preceding for the purpose of product development, competitive analysis, market intelligence and business intelligence.

### BACKGROUND OF THE INVENTION

Lost apparel, organisms and vulnerable people such as children, cognitively impaired individuals or seniors with dementia are major social problems: loss stresses the lost organism or person, the item/organism owner/guardian, and government and non-governmental agencies as they facilitate the return of the lost items or organisms.

Existing solutions including lost and found bins, personalized labels, and digitally enabled location or return devices suffer from a few major drawbacks: they do not effectively get lost items or organisms back to their owners or guardians, they do not allow the fully anonymous, direct communication about, or return of, these items or organisms to their owners/guardians, and they are often not very user friendly to the people who find lost items/organisms and try to return them. Instead they disclose identifying or contact information for owner/guardian or person returning the item/organism to successfully complete the return of the item/organism, or mediate return via additional people which adds time and cost. This prevents many people from participating in lost item return due to concerns about their time, convenience, safety or comfort(unwanted communication) after the return of the item and may make them the target of identity theft or other harmful situations.

In the case of the ReturnMe.com service, a person may register a ReturnMe.com lost item return tag for an annual fee and in the event of the loss of the item, anyone who finds it can call or email a company intermediary to facilitate return shipping the item to its owner. The perceived friction of involving another person in return of the lost item is repellent to consumers, as are the designs of the lost item return tags which are perceived to be bulky, and unattractive.

In the case of Karmik return labels, the device reading the QR code on the tag or retrieving information for the ID# on the tag from the Karmik website fills out a form and then receives a response with the contact information of the owner. This requires the person who found the tag to also disclose their contact information in the process of communicating with the owner of the tag. Transfer of ownership of the label is specifically forbidden in the terms and conditions. The labels are not designed for application on textile or apparel items, especially textile or apparel items that are laundered. Further, the language of the tag isn’t easily understood by people who speak other languages or have extremely basic reading comprehension or literacy. People who find lost items are rewarded with Karmik labels which they may not find desirable.

In the case of DynoTag lost item return labels, the device reading the QR code on the tag or retrieving information for the ID# on the tag from the DynoTag website only sees the contact information of the tag owner. This requires the person who found the tag to also disclose their contact information in the process of communicating with the owner of the tag. Transfer of ownership is not mentioned as a benefit or feature of this tag. The labels are not designed for application on textile or apparel items, especially textile or apparel items that are laundered. Further, the language of the tag isn’t easily understood by people who speak other languages or have extremely basic reading comprehension or literacy. Owners must choose a way to reward the people finding their lost item.

In the case of Apple AirTags, owners of the active bluetooth tag may track the tag on a map. However, if the tag moves because somebody has found it, the owner relies on a person who finds the lost tag knowing to place their mobile device on or near the tag to have the device “read” the information on the tag, and there are many consumers who can’t figure this out. The person who tries to have their device “read” the tag is likely to experience difficulty with their device reading the tag, especially if it is not an iOS device. Additionally, even if they are successful at reading the information on the tag, they can only communicate with the owner of the tag if the owner of the tag has disclosed their contact information. This requires the person who found the tag to also disclose their contact information in the process of communicating with the owner of the tag. Further, it puts the finder in the uncomfortable position of having a stranger show up where they/the tag are located which may make them feel unsafe. Further, the tag’s battery must be replaced every 10-12 months. Owners must choose a way to reward the people finding their lost item. Further, there is a maximum number of tags a given owner can own/manage.

In the case of Tile, owners of the active bluetooth tag may track the tag on a map. However, if the tag moves because somebody has found it, the owner relies on a person who finds the lost tag downloading the Tile app to communicate with the owner of the item. Given general hesitation for any consumer with a smartphone to download a new app, Tile specifically warns people who find their tags to ensure they are in a safe place because a stranger may show up where they/the tag are located. Further, the tag’s battery must be replaced every 10-12 months. The language of the supporting interface isn’t easily understood by people who speak other languages or have extremely basic reading comprehension or literacy. Owners must choose a way to reward the people finding their lost item.

### OBJECT OF THE INVENTION

The object of the invention is to remedy the shortcomings noted above: the inability to protect textile items; the difficulty in communicating with the owner of the item the tag/label is affixed to; the difficulty in accessing information related to the tag/label; the exposure of the identity and/or contact information of both the owner of the tag or label, their backup contact or agent acting on their behalf, and the identity and/or contact information of the person finding the item to which the tag or label is affixed; the inability to easily transfer ownership of the tag or label to someone else; difficulty removing the label or tag from an item that is donated or resold, thereby damaging the item or requiring additional cleaning; limitations on or difficulty managing ownership of multiple items; inability of the tag or label to stay affixed to the item through normal wear, tear and laundering; the inability to anonymously pay a reward to persons returning lost items that they find desirable; the lack of safe communication with the owner of an item for the purpose of returning a lost or vulnerable person or organism, brand ambassadorship, team affiliation, social or professional reasons; display of social/team/organizational/brand affiliations or ambassadorships and subsequent measurement of engagement with that information, the lack of a lost item return capability installed by the manufacturer during manufacture of the item which remedies the previously noted shortcomings- consumers do not want to go out of their way to purchase these labels or tags separately and install them themselves. Previously existing VIN or serial numbers and information about the related item stored in a database could also remedy situations where consumers don’t want to apply a label or tag to an item that already has a unique identifier. Further, as items are used, repaired or modified, none of the solutions on the market record or make use of this information to help identify the item, differentiate between authentic or unauthorized/counterfeit items, facilitate repair/modifications/servicing of the item, or recall defective items with specific manufacturing dates, batches, locations, components or materials; the invention remedies these points as well. Data generated with respect to each of these facets of the invention is itself an important part of the invention and used for product development, business intelligence, market intelligence and related uses.

### BRIEF DESCRIPTION OF THE INVENTION

For the aforementioned purposes and remedies, the invention comprises:
An ID# and information about the item stored in a database
A previously existing VIN or serial number and information about the item stored in a database
A corresponding anonymized communication interface(internet or network enabled webpage, app page, voice activated interface) for each unique ID# which allows safe and anonymous communication between the owner of the item the invention is applied to(or their backup contact) and the person interacting with the item the invention is applied to which may also display information the owner has chosen to disclose about their team, brand, or professional affiliations, membership in a particular group, or social data for the purpose of meeting new people, dating, highlighting hobbies, use of equipment or items, engagement, or measurement of these aspects for the purpose of quantifying value or engagement
A corresponding ownership record for each unique ID# including information about the item, any instructions from the manufacturer about the use, repair, servicing, recall, or end of life disposal of the item
Materials and methods allowing permanent installation of the invention by manufacturers or qualified service professionals, or permanent or semi-permanent installation of the invention by consumers
The ability to easily transfer ownership of the tag or label to someone else
Ability to manage ownership of multiple items or multiple owners of multiple items;
The ability to anonymously pay a reward that persons returning lost items find desirable by allowing choice of increasing specificity based on dietary, brand or other preferences
The ability for a manufacturer to customize and install the invention during manufacture of the item
The ability to record ownership history, usage, repairs, modifications, warranty or recall history of the item
The ability to differentiate between authentic or unauthorized/counterfeit items via the ID# and associated record,
The ability to facilitate repair/modifications/servicing of the item and communicate with the owner regarding completion, tracking information, status, or further instructions
The ability to issue communications, instructions or remedies for recall of defective items including but not limited to items produced on specific manufacturing dates, in certain batches, in certain locations, or with certain components or materials.
The ability to gather data on all aspects of the invention for the purpose of business intelligence, market intelligence, product development and related uses

In one development, the invention is composed of the ID#, and instructional URL that communicates the URL and ID# can be used to return or communicate anonymously about the item

In another development, the invention is composed of a previously existing serial number and brand entered into the website/interface as long as a record already exists in the database for that serial number and brand combination

In another development, the invention is composed of the ID#, instructional URL and a QR code that the person interacting with the invention can use to return or communicate anonymously about the item

In another development, the invention is composed of either of “I’m lost” or “If found” and a QR code

In another development, the invention is composed of either of “I’m lost” or “if found,” an ID#, a URL

In another development, the invention is composed of either of “I’m lost” or “if found,” an ID#, a URL, and manufacturer brand and/or size information

For the purpose of returning lost children or vulnerable persons, the invention is applied to the skin, external surfaces of garments, accessories, shoes or other items where it is easily seen while being worn by these children or vulnerable persons: sleeves, chest, front of hats, the back palm on gloves, on the tongue or laces or similar area of shoes especially. The invention may also take the form of a printed bracelet.

For the purpose of returning lost items, the invention should be applied as close as possible to the branding of a given item or in a prominent place if the branding is hidden. This may mean back of neck in shirts, jackets, tops; back of waistband in pants or bottoms; brims of hats; back of palm or wristband on gloves; interior of backpacks or purses near openings; interior or exterior of wallets; back of phones; inner surface of eyeglass legs; both sides of house keys; back of car key clickers/fobs; backs or exterior tongues of footwear; upper cuff of socks; backside of watch cases; near the binding on skis; on the grip or upper portion of ski/hiking poles; on the outer surface of hearing aids or earbuds/earphones; on the plug assembly of chargers; as an appendage on charging cables; on the front or back of ID or bank/payment cards; on the front of documents or front cover if documents have a cover.

### BRIEF DESCRIPTION OF THE DRAWINGS

FIG. 1 Device printed directly onto item- in this case, a house key

FIG. 2 Manufacturer-installed device(device has been printed onto a coated fabric which is then sewn onto a glove)

FIG. 3 Manufacturer-installed device(device has been reverse-printed onto a heat applied film and contains brand information and size in addition to “I’m lost,” QR code and ID#)

FIG. 4 Owner registration of manufacturer-installed device along with backup contact information

FIG. 5A Manufacturer-/qualified professional-installed device data example used to print device into or onto item

FIG. 5B Manufacturer-/qualified professional-installed device ownership and repair history data example

FIG. 6 Owner view of Manufacturer-/qualified professional-installed device with repair history

FIG. 7A Devices printed onto film and installed by consumer - semi-permanent (device on earbud case: “I’m lost,” ID# and QR code; devices on earbuds: URL, ID#)

FIG. 7B Device printed onto film and installed by consumer - semi-permanent (Eyewear device: URL and ID#)

FIG. 7C Device reverse-printed onto heat seal film for extra durability - permanent

FIG. 7D Device printed onto heat seal film - permanent

FIG. 8A Anonymous communication between the device owner and the device finder (finder view)

FIG. 8B Anonymous communication between the device owner and the device finder (owner and backup contact view)

FIG. 9 Example notification about new anonymous communication between the device owner and the device finder based on recipient’s preferences

FIG. 10A Anonymous reward options for reward recipient to choose from

FIG. 10B Anonymous reward options increasing in specificity

FIG. 10C Anonymous reward recipient information

FIG. 11 Owner-displayed information on device’s anonymous chat page

FIG. 12 Additional owner-displayed information linked from device’s anonymous chat page

FIG. 13 Device-item information - product detail/ambassador use case

FIG. 14A Ownership of multiple ID#s

FIG. 14B Ownership cessation or transfer

FIG. 15A Vulnerable person return (sleeve)

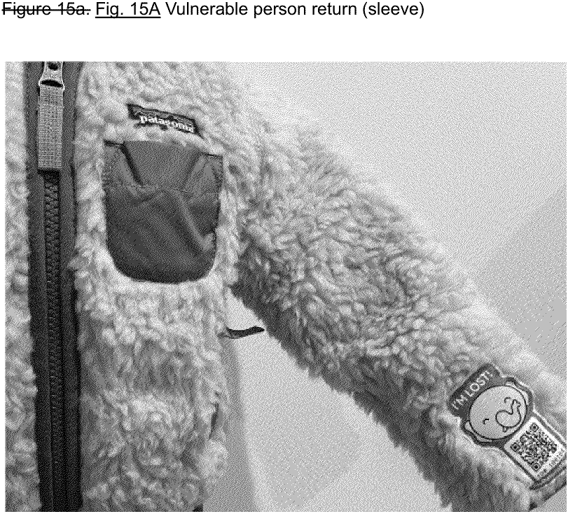

FIG. 15B Vulnerable person return (glove)

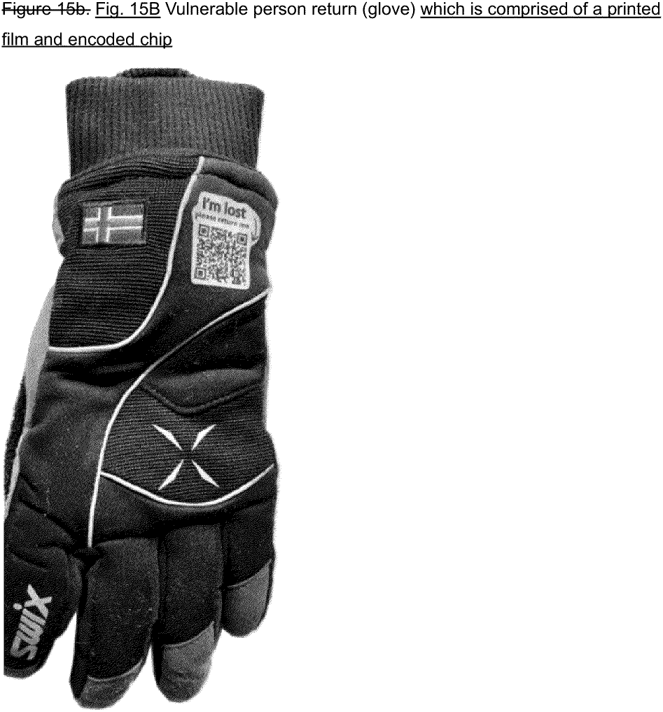

### DETAILED DESCRIPTION OF THE INVENTION

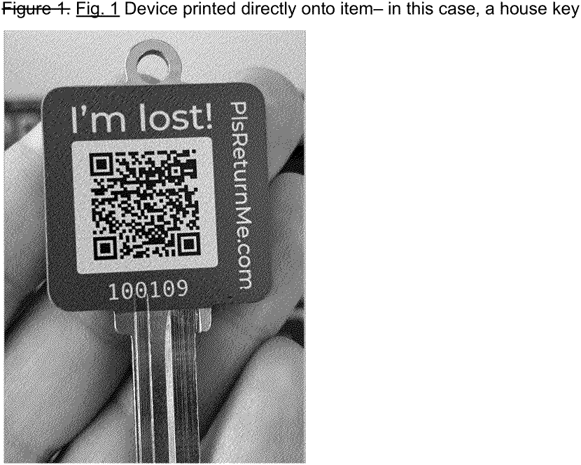

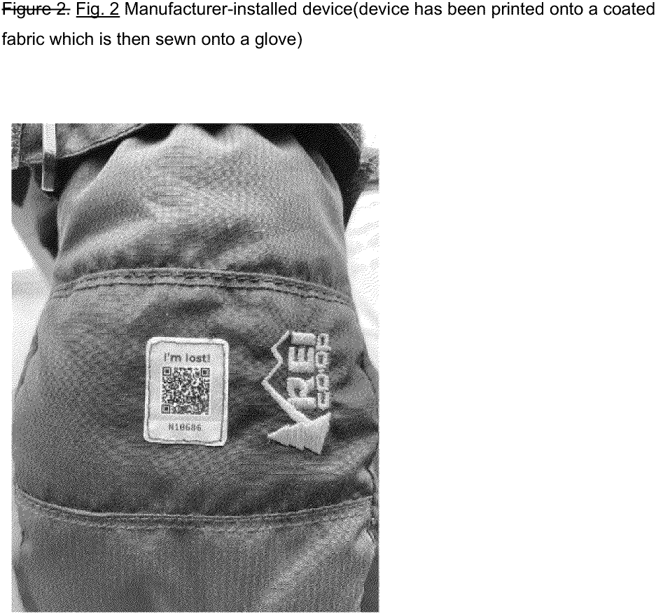

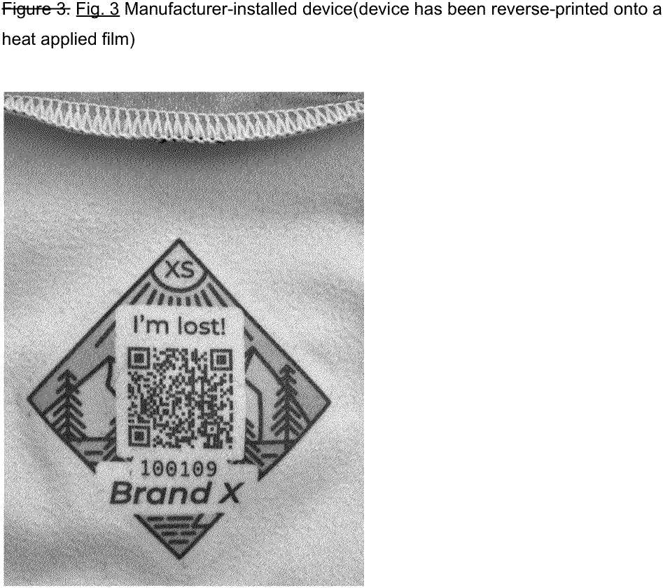

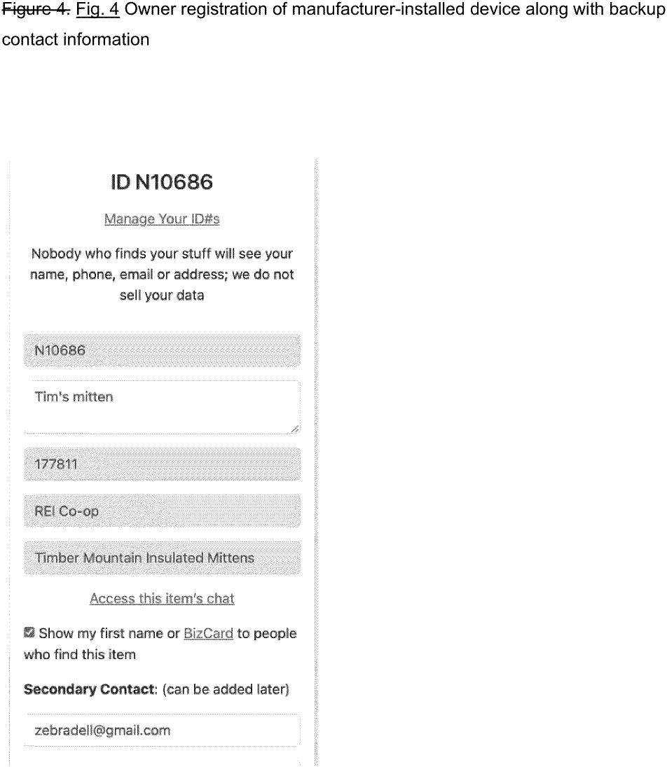

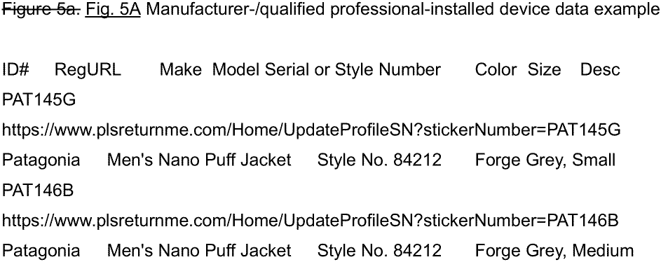

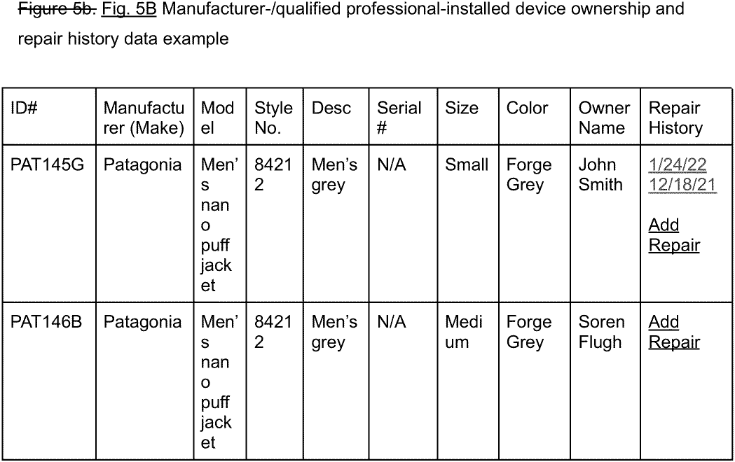

The invention is applied either by a manufacturer, or a consumer. In the case of a manufacturer, which has never been done before in any of the prior art encountered, they provide a data file containing the make, model, style no., applicable serial number, color, and size for the items that will have receive the invention/device as well as the quantity of each item corresponding to the number of invention/devices. The records for these manufactured items are loaded into the database and the corresponding ID#s and URLs are generated. At this point, an output file containing the original information plus the corresponding ID#s, URLs and any other data desired to be printed on the items is generated(FIG. 5A). The device is then printed directly onto the item (FIG. 1) by the manufacturer using a data file or alternatively, the device is printed onto or into a chip or label that will be sewn(FIG. 2), or heat sealed/applied/adhered to the item(FIG. 3). The finished item is then purchased and registered (FIG. 4) by the owner and the owner can designate a backup contact for the item.

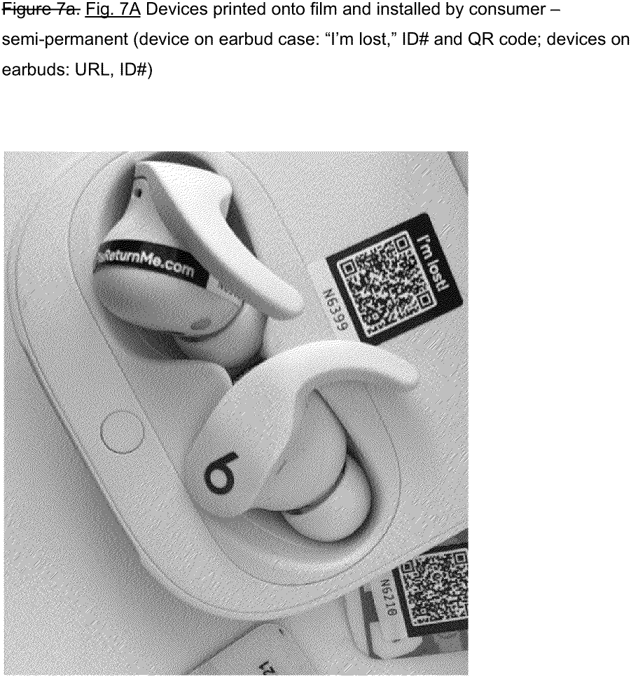

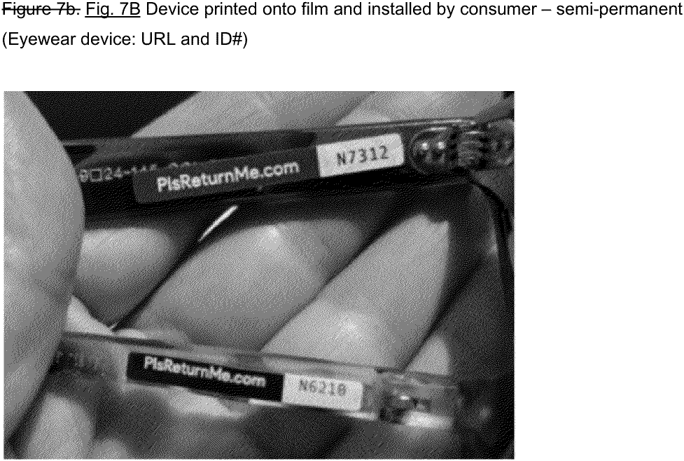

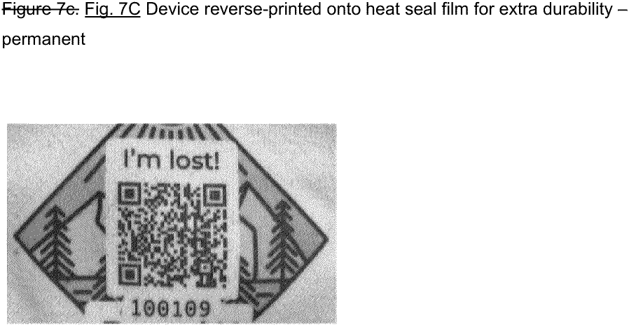

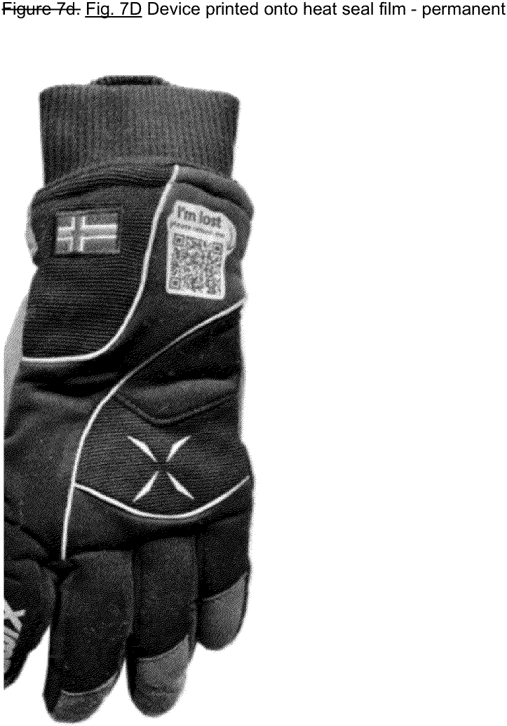

In the case of the invention being applied by the consumer(FIGS. 7A, 7B, 7C, 7D), the corresponding ID#(s) is registered, a description of the item and an optional photo are added, and a backup contact is designated(the designation of a backup contact appears to be new compared to the prior art).

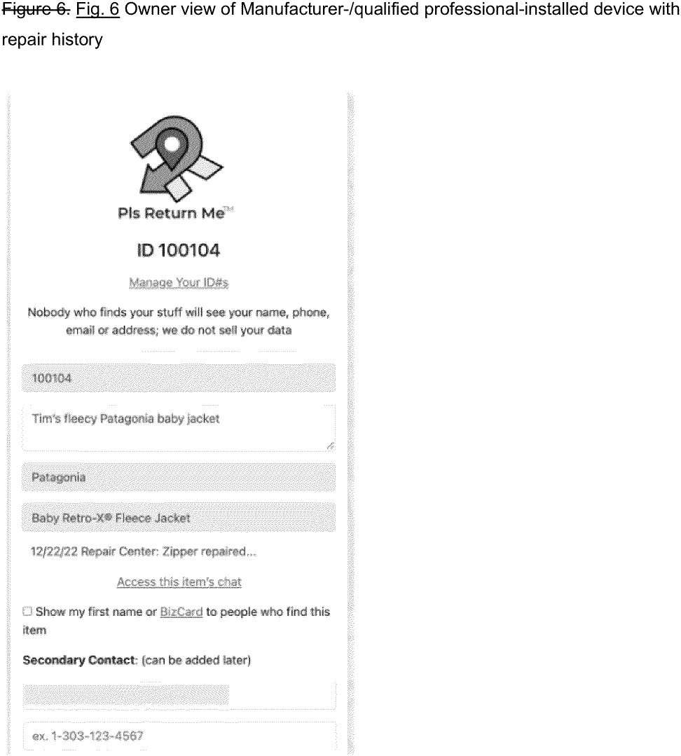

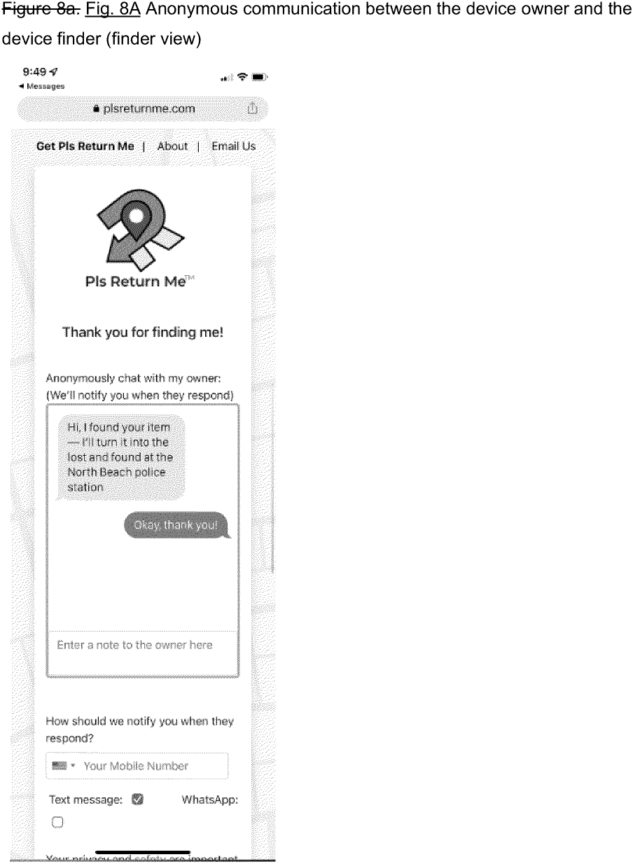

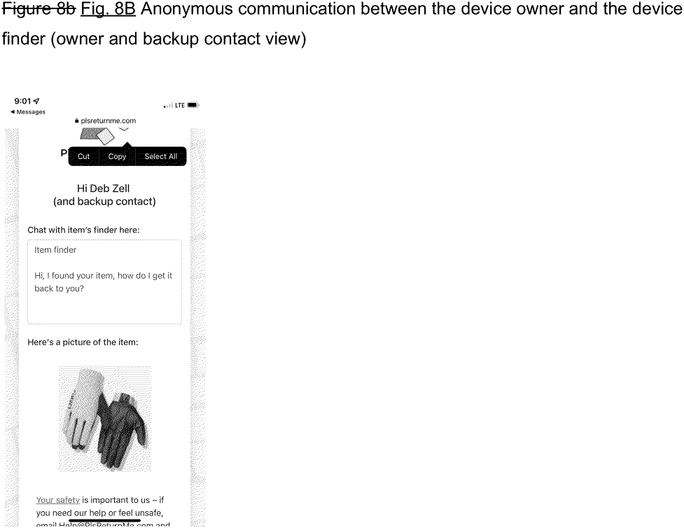

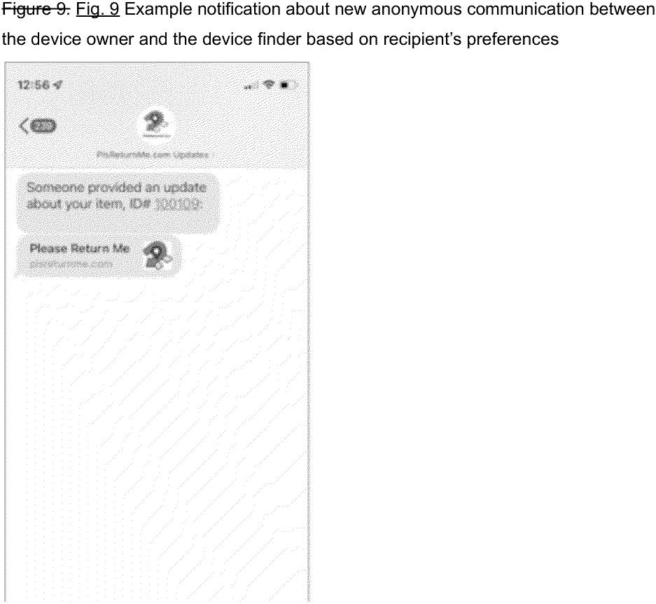

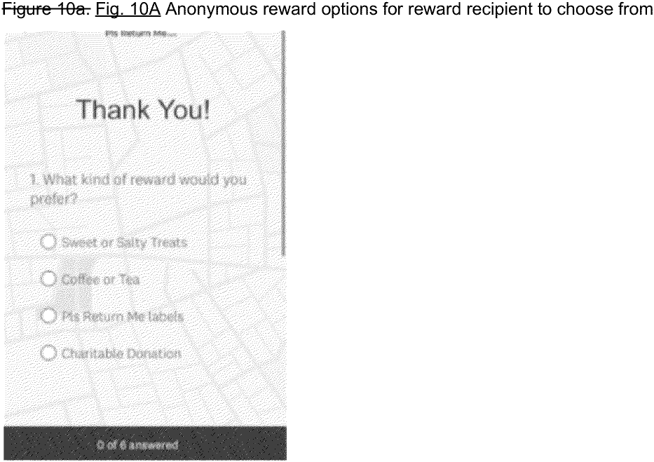

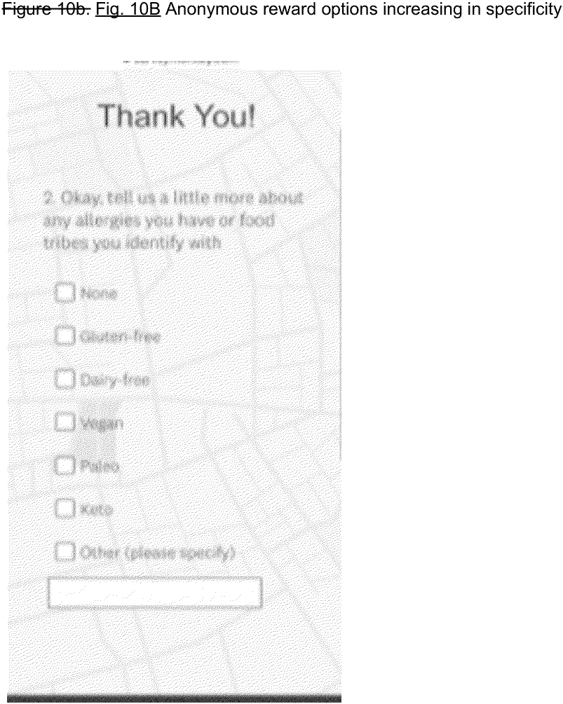

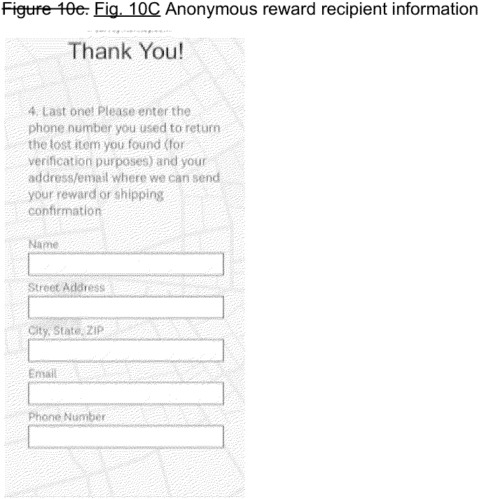

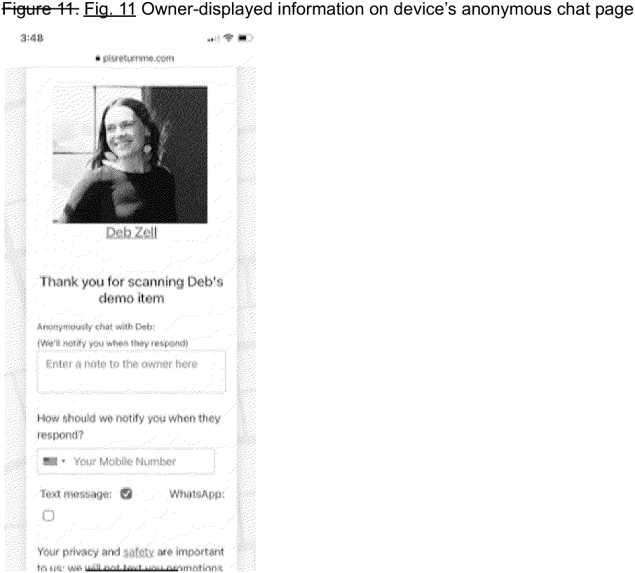

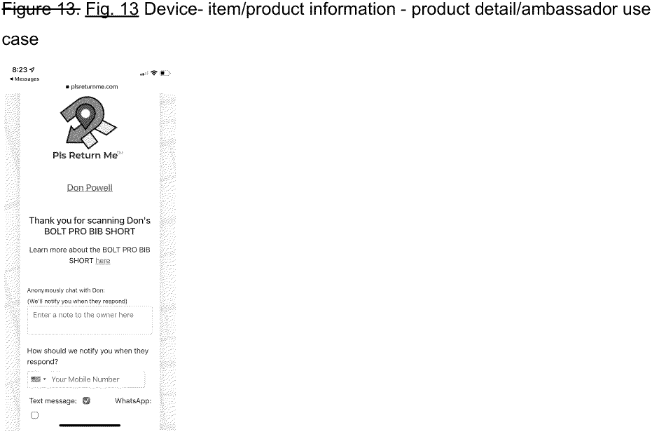

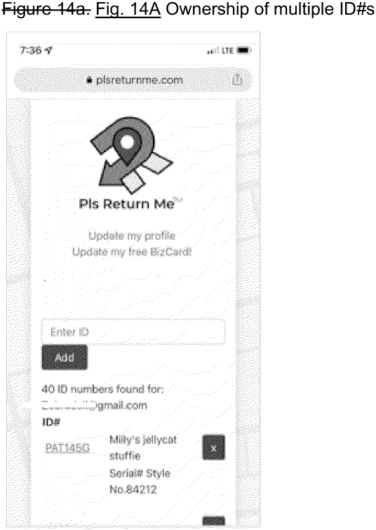

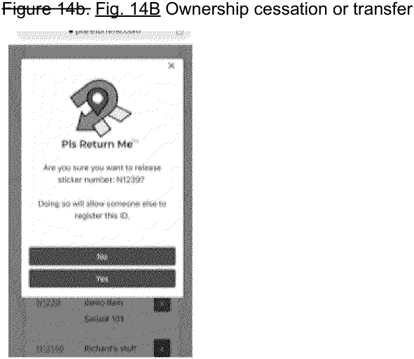

As the owner uses the item and requires repair of the item or experiences some defect, these are entered into the item’s record by the manufacturer or authorized repair professionals (FIG. 5B) and viewable by the current owner or future owners of that item (FIG. 6); this is a completely new capability not found in any of the prior art. The manufacturer may also update the item’s record(FIG. 5B) to notify the owner of any defect or recall requiring repair, servicing or some other resolution; this is a completely new capability not found in any of the prior art. In cases where the owner loses an item, or where a child or vulnerable person such as a senior with dementia is wearing an item with the invention applied(completely new use of return service not found in any of the prior art), the person finding the item/person can communicate directly and anonymously with the owner/guardian or the owner/guardian’s designated backup contact (FIGS. 8A, 8B), with each receiving notifications about updates in that communication (FIG. 9); this is a completely new capability not found in any of the prior art. If the person who found the item fails to contact the owner or their designated backup contact, there is an option for that person to receive an anonymous prepaid shipping label to return the item directly to the owner; this is a completely new capability not found in any of the prior art. In the case of lost children or vulnerable persons, the contact information and address of the registered owner/guardian is provided to the police or other governmental agencies who will ensure safe return of the child/vulnerable person/senior citizen; this is a completely new capability not found in any of the prior art. Those options are available to the person who found the item/person when they email the help@plsreturnme.com email address per the instruction in the finder view of the anonymous communication interface(FIG. 8A) and include the relevant ID#; these are completely new capabilities not found in any of the prior art. When the owner receives their item back, or the tracking information for a shipped item indicates it has been delivered, the case is closed and the person who returned the item can receive an anonymous reward of their choice(FIGS. 10A, 10B) delivered to them anonymously (FIG. 10C); this is a completely new capability not found in any of the prior art. Outside of lost item return, the registered owner of the item the invention is applied to may choose to make information about themselves visible; this is a completely new capability not found in any of the prior art. This information could include professional or social information (FIGS. 11,12) or in the case of brand ambassadors, sponsored athletes or consumers who simply want to show off information about the items they own to which the invention has been applied, this could be product information or links to additional information about the product (FIG. 13); again, this is a completely new capability not found in any of the prior art. Owners of items to which the device has been applied can see all of their items in one place (FIG. 14A) and as they donate, resell, or gift items to others, they can end or transfer their ownership of that item (FIG. 14B); this is a completely new capability not found in any of the prior art.

Abstract: The invention is an identifier(device) installed by a manufacturer, qualified professional or consumer and a (method) for managing all aspects of an item’s lifecycle: ownership, anonymous return of(or communication via) the item or person/organism bearing the identifier, anonymous reward for the return of the lost item or person/organism, authentication and warranty(repair or recall) recordkeeping and management for a given item, transfer of ownership of an item, end of life recycling when the item has achieved its usable lifespan, and data generated from the preceding for the purpose of product development, competitive analysis, market intelligence and business intelligence.

1. An identifier comprising visibly or invisibly printed(encoded), tattooed, or engraved data containing 2 or more of the following:
• ID#
• link to communication interface for the given ID#, whether as a URL or encoded into a barcode, QR code, electronic device such as a chip, network, gesture or voice controlled interface that communicates with a database
“I’m lost” or “If found”
• Applied directly to item or affixed to surface of item as depicted in Figures 1, 2, 3 and 7.

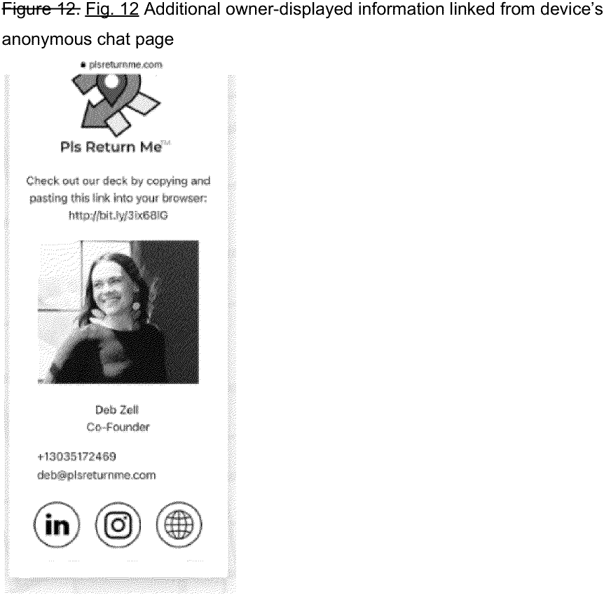

2. The device is installed by consumer/owner, who:
• Assumes ownership of the device by adding the device’s ID# to the list of device ID#s they own
• Creates a record for the item the device is installed in or on with description, photo, and when applicable: make, model, style number, or serial number
• Specifies their own contact preferences for receiving notifications from the device’s anonymous chat, and specifies additional persons or entities and their contact information for the purpose of receiving anonymous chat notifications or return of item when owner is unable to do so themselves (Figure 4)
• Communicates anonymously about the device or item/organism bearing the device via the associated interface or through notifications delivered according to their contact preferences (Figures 8 and 9)
• May pay an anonymous reward to the person or entity returning the item when lost (Figure 10)
• May choose to include and display their name, affiliation(s) with teams, brands, or organizations, display social information, professional information, a photo, or links to publications websites, information about the item the device is installed on, or other items they’ve installed devices on and claimownership of (Figures 11, 12 and 13).

3. The device is installed on an item during that item’s manufacture or after manufacture by a qualified professional or warranty/service provider
• The device’s record in the database is updated with :
i. Description, make, model, style number, serial number, identifier in a public ledger system, features of item device is installed on, links to webpages or other resources about the item the device has been installed on (Figures 5, 6 and 13)
ii. Any applicable warranty terms, status, availability, repair history, repair providers, service contacts, instructions, end of life disposal (Figure 6)
iii. Manufacturers and qualified professional warranty/service providers are able to view the device’s ownership history (Figure 5)
iv. The device is registered by the owner per claim 2:.

4. Ownership of a given device can be released, sold or transferred by release of the device’s ID# from the list of ID#s they own
• Owners of items bearing a device can be list these items for sale
• Items bearing attributes stored in the item’s device can be requested for purchase or purchased if the owner agrees.

5. Payment of anonymous rewards
• Anonymous rewards keep the identities of the payer and recipient anonymous from each other and may be paid as money, products, points, services, or other units of value
• Reward options are presented to recipient and they receive their desired option (Figure 10)
• Reward options, recipient selections, and demographic data are gathered and used for product or service development, competitive analysis, or behavioral insights.

6. Collection of data with respect to the preceding claims is used for product development, competitive analysis, market analysis, market penetration, demographic analysis, behavioral analysis, and warranty and repair prediction, product improvement and.
